(19) United States
(12) Patent Application Publication
(10) Pub. No.: US 2019/0141954 A1
(43) Pub. Date: May 16, 2019

(54) PET TOY

(71) Applicant: TONGFU MANUFACTURING CO., LTD., Nanjing (CN)

(72) Inventors: Huixin YUAN, Nanjing (CN); Wen ZHANG, Nanjing (CN)

(73) Assignee: TONGFU MANUFACTURING CO., LTD., Nanjing (CN)

(21) Appl. No.: 16/188,675

(22) Filed: Nov. 13, 2018

(30) Foreign Application Priority Data
Nov. 14, 2017 (CN) 201711118947.2

(51) Int. Cl. A01K 15/02

(52) U.S. Cl. CPC A01K 15/025; A01K 5/0114

(57) ABSTRACT

The present invention relates to an improved pet toy, including a chamber, where the chamber is hollow, and a slide rod is disposed inside the chamber; the slide rod is movably threaded with several pet treats, and two ends thereof are connected to the chamber, so that the pet treats are securely contained inside the chamber and do not detach from the slide rod; and the chamber is provided with a window, to enable a pet to see and to chew the pet treats inside the chamber. The present invention is feasible in design, simple in structure, easy to use, and can effectively prolong attraction of a toy to a pet and boost vitality of the pet. Meanwhile, a solid structure of the present invention is durable enough to resist tough biting and beating of a pet.

### BACKGROUND

### Technical Field

The present invention relates to a pet toy, in particular, to a toy that is improved to be capable of continuously attracting a pet, and specifically, to an improved pet toy.

### Related Art

Currently, common pet toys in the market are designed to be attached with treats, to increase attraction of toys to pets. However, treats on existing products are usually eaten up by pets within a short time, and after the treats have been eaten up, pets will lose interest in the toys. Therefore, it is needed to design a toy capable of generating attraction to a pet for a relatively long time, to satisfy market demands.

### SUMMARY

An objective of the present invention is to provide, with regard to disadvantages in the prior art, an improved pet toy, combining pet treats with the toy, to effectively prolong attraction of the toy to a pet, boost vitality of the pet, and satisfy market demands.

Technical solutions of the present invention include the following:

An improved pet toy is provided, including a chamber, where the chamber is hollow, and a slide rod is disposed inside the chamber; the slide rod is movably threaded with several pet treats, and two ends thereof are connected to the chamber, so that the pet treats are securely contained inside the chamber and do not detach from the slide rod; and the chamber is provided with a window, to enable a pet to see and to chew the pet treats inside the chamber.

Further, the chamber is made of hard nylon, so that the chamber is durable enough to resist tough beating and biting.

Further, an exterior of the chamber is wrapped up with elastic plastic material, which can reduce noise and prevent damage to pet teeth.

Further, one end of the chamber is provided with a threaded through-hole, and the other end thereof is provided with a hole; one end of the slide rod is provided with a threaded end cover, and the other end thereof is a free end; and the free end can be inserted into the hole after penetrating through the through-hole, and enable the end cover to be spirally connected to the through-hole, to fix the slide rod to the chamber.

Further, the chamber is in a shape to attract a pet; and the end cover is a part of the shape of the chamber, to make the entire chamber more complete and appealing.

Further, an outer surface of the chamber or the end cover is provided with a plurality of protrusions, to facilitate cleaning teeth of a pet.

Further, a circular hole is provided in the middle of the pet treats; and a diameter of the circular hole is larger than an outer diameter of the slide rod, so that the pet treats can be sleeved over the slide rod and flexibly slide along the slide rod.

The beneficial effects of the present invention are:

The present invention is feasible in design, simple in structure, easy to use, and can effectively prolong attraction of a toy to a pet and boost vitality of the pet. Meanwhile, the present invention has a stable structure, can resist tough biting and beating of a pet, and is durable in use.

### BRIEF DESCRIPTION OF THE DRAWINGS

FIG. 1 is a schematic diagram of the present invention in a bone shape when the present invention is dismantled;

FIG. 2 is a schematic diagram of the present invention in a bone shape when the present invention is assembled;

FIG. 3 is a schematic diagram of a pet treat according to the present invention;

FIG. 4 is a schematic diagram of the present invention in a crocodile shape when the present invention is dismantled; and

FIG. 5 is a schematic diagram of the present invention in a crocodile shape when the present invention is assembled.

1-hole; 2-window; 3-chamber; 4-pet treat; 5-end cover; 6-protrusion; 7-slide rod; 8-through-hole.

### DETAILED DESCRIPTION

The following further describes the present invention with reference to the accompanying drawings and embodiments.

### Embodiment 1

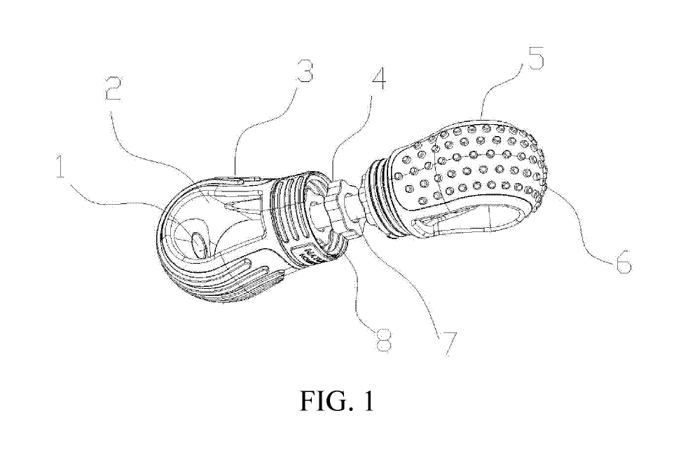

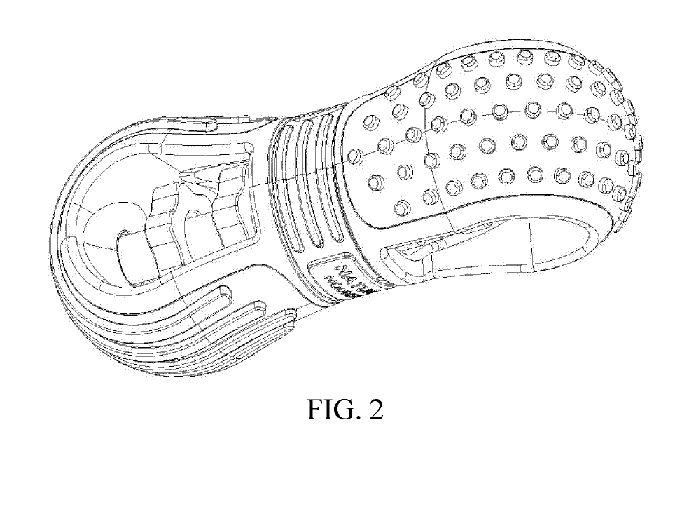

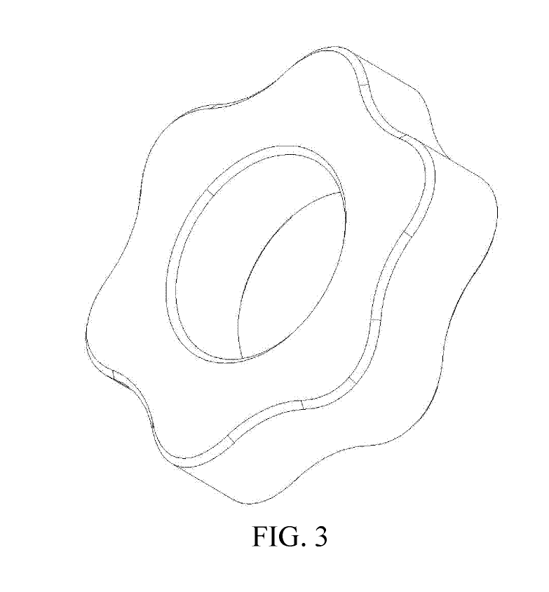

As shown in FIG. 1 to FIG. 3, an improved pet toy includes a chamber 3. The chamber 3 is hollow, and a slide rod 7 is disposed inside the chamber 3. One end of the chamber 3 is provided with a threaded through-hole 8, and the other end thereof is provided with a hole 1; one end of the slide rod 7 is provided with a threaded end cover 5, and the other end thereof is a free end; and the free end can be inserted into the hole 1 after penetrating through the through-hole 8, and enable the end cover 5 to be spirally connected to the through-hole 8, to fix the slide rod 7 to the chamber 3. The slide rod 7 is threaded with several pet treats 4, and the pet treats can be securely contained inside the chamber 3. Meanwhile, as two ends of the slide rod 7 are both blocked, the pet treats 4 do not detach from the slide rod 7, and it can help continuously attract a pet.

The chamber 3 and the end cover 5 are both halves of a bone shape, so that after being connected together, the chamber 3 and the end cover 5 form a complete bone, and it would be easy to attract a pet. The chamber 3 is provided with a window 2, to enable a pet to see and to chew the pet treats 4 inside the chamber 3.

The pet treat 4 may be in any shape, and a circular hole is provided in the middle thereof. A diameter of the circular hole is larger than an outer diameter of the slide rod 7, so that the pet treats 4 can be sleeved over the slide rod 7 and flexibly slide along the slide rod 7. Meanwhile, a diameter of the through-hole 8 is larger than an outer diameter of the pet treats 4, so as to facilitate the pet treats 4 sliding between the chamber 3 and the end cover 5, and increase the attraction of the toy. Correspondingly, the end cover 5 is also provided with a window, to enable a pet to see and to chew a pet treat that is slid to the end cover 5.

Outer surfaces of the chamber 3 and the end cover 5 are respectively provided with a plurality of protrusions 6, to facilitate cleaning teeth of a pet. The protrusions on the chamber 3 are in a stripe shape, and the protrusions 6 on the end cover 5 are spikes or in a stripe shape. It helps attract a pet and massage its gums or clean its teeth.

The chamber 3 is made of hard nylon, so that the chamber 3 is durable enough to resist beating and biting. An exterior of the chamber 3 may further be wrapped up with elastic plastic material and can reduce noise and prevent damage to pet teeth.

After the pet treats are all eaten up by a pet, the end cover can be unscrewed, and the slide rod is taken out. New pet treats can be placed on the slide rod, and then, the slide rod is mounted into the chamber again, so that the pet can be attracted again, reuse is implemented, and a service life is prolonged.

### Embodiment 2

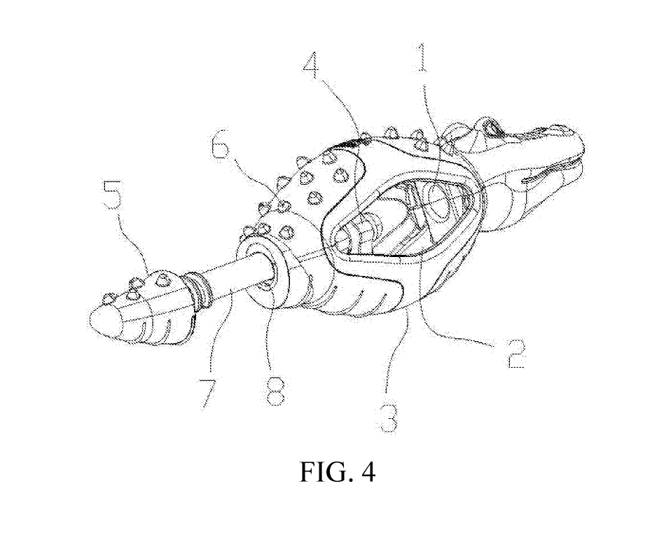

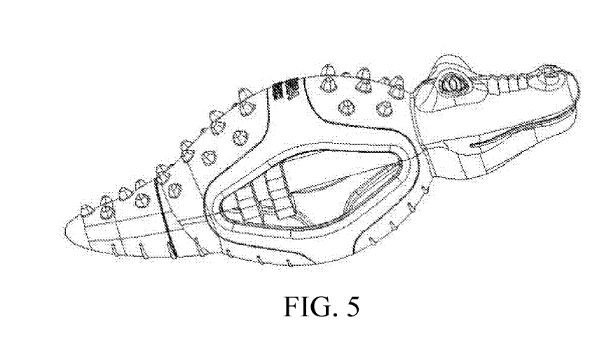

As shown in FIG. 4 and FIG. 5, this embodiment mainly differs from Embodiment 1 in that the chamber 3 in this embodiment is in a crocodile shape and is provided with two oppositely disposed windows 2. The end cover 5 of the slide rod 7 is a tail of a crocodile, and after the end cover 5 is mounted, the end cover 5 and the chamber 3 can form a complete crocodile shape, so that an appearance is more complete and appealing. An upper part of the chamber 3 is provided with spikes, and a lower part thereof is provided with stripe-shaped protrusions. A diameter of the through-hole 8 is smaller than an outer diameter of the pet treat 4, so that the pet treat 4 is securely contained inside the crocodile-shaped chamber.

A shape of the chamber of the present invention may alternatively be another animal shape, a food shape, or the like. The pet treat may alternatively be in another shape provided that it can be disposed inside the chamber and flexibly slide along the slide rod.

Parts not described in the present invention are all the same as the prior art or may be performed by using the prior art.

What is claimed is:

1. An improved pet toy, comprising a chamber, wherein the chamber is hollow, and a slide rod is disposed inside the chamber; the slide rod is movably threaded with several pet treats, and two ends thereof are connected to the chamber, so that the pet treats are securely contained inside the chamber and do not detach from the slide rod; and the chamber is provided with a window, to enable a pet to see and to chew the pet treats inside the chamber.

2. The improved pet toy according to claim 1, wherein the chamber is made of hard nylon, so that the chamber is durable enough to resist beating and biting.

3. The improved pet toy according to claim 1, wherein an exterior of the chamber is wrapped up with elastic plastic material and can reduce noise and prevent damage to pet teeth.

4. The improved pet toy according to claim 1, wherein one end of the chamber is provided with a threaded through-hole, and the other end thereof is provided with a hole;
one end of the slide rod is provided with a threaded end cover, and the other end thereof is a free end; and the free end can be inserted into the hole after penetrating through the through-hole, and enable the end cover to be spirally connected to the through-hole, to fix the slide rod to the chamber.

5. The improved pet toy according to claim 1, wherein the chamber is in a shape to attract a pet; and the end cover is a part of the shape of the chamber, to make the entire chamber more complete and appealing.

6. The improved pet toy according to claim 1, wherein an outer surface of the chamber or the end cover is provided with a plurality of protrusions, to facilitate cleaning teeth of a pet.

7. The improved pet toy according to claim 1, wherein a circular hole is provided in the middle of the pet treats; and a diameter of the circular hole is larger than an outer diameter of the slide rod, so that the pet treats can be sleeved over the slide rod and flexibly slide along the slide rod.
